(19) United States
(12) Patent Application Publication
(10) Pub. No.: US 2011/0015031 A1
(43) Pub. Date: Jan. 20, 2011

(54) CONTINUOUSLY VARIABLE TRANSMISSION (CVT) HAVING A COAXIAL INPUT/OUTPUT ARRANGEMENT AND ENHANCED EMBEDDED TORQUE TRANSFER

(76) Inventors: Jean-Francois Dionne, Saint-Hubert (CA); Louis-Philippe Menard, Montreal (CA); Kenneth Huston, Montreal (CA); Samuel Beaudoin, Yamaska (CA); Jean-Robert Desmeules, Montreal (CA); Paul Okulov, Saint-Anne-de-Bellevue (CA)

Correspondence Address: FISH & RICHARDSON P.C. (BO), P.O. BOX 1022, MINNEAPOLIS, MN, 55440-1022, US

(21) Appl. No.: 12/816,132

(22) Filed: Jun. 15, 2010

Related U.S. Application Data
(60) Provisional application No. 61/226,816, filed on Jul. 20, 2009.

(51) Int. Cl. F16H 37/02

(52) U.S. Cl. 476/31

(57) ABSTRACT

A dual-cavity toroidal Continuously Variable Transmission provided with co-axial input/output arrangement where a drum assembly is used to transfer torque from a central driven disk of the CVT to the output shaft of the CVT and including at least one embedded resilient member to reduce torque fluctuations present in the CVT.

### CROSS REFERENCE TO RELATED APPLICATIONS

This application claims the benefit under 35 USC 119(e) from U.S. Patent Application Ser. No. 61/226,816 entitled “A CONTINUOUSLY VARIABLE TRANSMISSION (CVT) HAVING A CO-AXIAL INPUT/OUTPUT ARRANGEMENT” filed in the United States Patent and Trademark Office on Jul. 20, 2009, the contents of which are incorporated herein by reference.

### FIELD

The present invention generally relates to continuously variable transmissions. More specifically, the present invention is concerned with a toroidal continuously variable transmission having a coaxial input/output arrangement and enhanced embedded torque transfer.

### BACKGROUND

Toroidal Continuously Variable Transmissions (hereinafter generically referred to as “CVT”) are believed known in the art. The operation of such a CVT will therefore only be briefly discussed herein.

Generally stated, a toroidal CVT is provided with a drive disk having a toroidal surface, a driven disk also having a toroidal surface, both disks being linked by rollers in contact with their respective toroidal surfaces. The angle of the rollers with respect to the drive and driven disks dictates the speed ratio between the driven and drive disks.

Often, toroidal CVTs are designed according to the so-called “dual cavity” configuration including two drive disks and a single driven disk having opposed toroidal surfaces and located between the two drive disks. When this is the case, one of the output and input of the CVT is provided about in the middle of the device, which may bring integration problems.

### BRIEF DESCRIPTION OF THE DRAWINGS

In the appended drawings:

FIG. 1 is a side elevation view of a CVT according to a first illustrative embodiment;

FIG. 2 is a sectional view of the CVT of FIG. 1;

FIG. 3 is an exploded view of the CVT of FIG. 1;

FIG. 4 is a perspective view of the drum of the CVT of FIG. 1, shown without the resilient members;

FIG. 5 is a perspective view similar to FIG. 4, illustrating the drum with the resilient elements;

FIG. 6 is a perspective view of a drum assembly according to a second illustrative embodiment;

FIG. 7 is a sectional view taken along line 7-7 of FIG. 6; and

FIG. 8 is an enlargement of a portion of FIG. 6.

### DETAILED DESCRIPTION

In accordance with an illustrative embodiment, there is provided a continuously variable transmission including:

a shaft defining a longitudinal axis; the shaft defining an input/output of the continuously variable transmission;

a first drive disk mounted to the shaft and provided with a toroidal surface;

a driven disk rotatably mounted to the shaft and having a first toroidal surface facing the toroidal surface of the first drive disk, a second toroidal surface and a peripheral surface;

a second drive disk mounted to the shaft and provided with a toroidal surface facing the second toroidal surface of the driven disk;

a first set of rollers interconnecting the toroidal surface of the first drive disk with the first toroidal surface of the driven disk;

a second set of rollers interconnecting the toroidal surface of the second drive disk with the second toroidal surface of the driven disk; and

a drum assembly enclosing one of the first and second drive disks; the drum assembly having a first longitudinal end defining an output/input of the continuously variable transmission and a second longitudinal end;

wherein a) the second longitudinal end of the drum assembly is resiliently interconnected to the driven disk and b) the resilient interconnection reduces torque fluctuations present in the continuously variable transmission.

According to another aspect, there is provided a continuously variable transmission including:

a shaft defining a longitudinal axis; the shaft defining an input/output of the continuously variable transmission;

a first drive disk mounted to the shaft and provided with a toroidal surface;

a driven disk rotatably mounted to the shaft and having a first toroidal surface facing the toroidal surface of the first drive disk, a second toroidal surface and a peripheral surface;

a second drive disk mounted to the shaft and provided with a toroidal surface facing the second toroidal surface of the driven disk;

a first set of rollers interconnecting the toroidal surface of the first drive disk with the first toroidal surface of the driven disk;

a second set of rollers interconnecting the toroidal surface of the second drive disk with the second toroidal surface of the driven disk;

a drum assembly enclosing one of the first and second drive disks; the drum assembly has a first longitudinal end defining an output/input of the continuously variable transmission and a second longitudinal end; and

at least one resilient element interconnecting the second longitudinal end of the drum assembly and the driven disk;

wherein the at least one resilient element reduces the torque fluctuation present in the continuously variable transmission.

According to another aspect, there is provided a continuously variable transmission including:

a shaft defining a longitudinal axis; the shaft defining an input/output of the continuously variable transmission;

a first drive disk mounted to the shaft and provided with a toroidal surface;

a driven disk rotatably mounted to the shaft and having a first toroidal surface facing the toroidal surface of the first drive disk, a second toroidal surface and a peripheral surface;

a second drive disk mounted to the shaft and provided with a toroidal surface facing the second toroidal surface of the driven disk;

a first set of rollers interconnecting the toroidal surface of the first drive disk with the first toroidal surface of the driven disk;

a second set of rollers interconnecting the toroidal surface of the second drive disk with the second toroidal surface of the driven disk; and

a drum assembly including a tubular drum provided with first and second longitudinal ends and an output/input shaft mounted to the first longitudinal end; the tubular drum being made of a resilient material and enclosing one of the first and second drive disk; the second longitudinal end being mounted to the driven disk;

wherein the resilient material of the tubular drum reduces torque fluctuations present in the continuously variable transmission.

According to yet another aspect, there is provided a continuously variable transmission including:

a shaft defining a longitudinal axis; the shaft defining an input/input of the continuously variable transmission;

a first drive disk mounted to the shaft and provided with a toroidal surface;

a driven disk rotatably mounted to the shaft and having a first toroidal surface facing the toroidal surface of the first drive disk, a second toroidal surface and a peripheral surface;

a second drive disk mounted to the shaft and provided with a toroidal surface facing the second toroidal surface of the driven disk;

a first set of rollers interconnecting the toroidal surface of the first drive disk with the first toroidal surface of the driven disk;

a second set of rollers interconnecting the toroidal surface of the second drive disk with the second toroidal surface of the driven disk;

a drum assembly enclosing one of the first and second drive disk; the drum assembly having a first longitudinal end defining an output/input of the continuously variable transmission and a second longitudinal end connected to the peripheral surface of the driven disk; and

at least one resilient member so associated with at least one of the longitudinal shaft, the first drive disk, the second drive disk, the driven disk and the drum assembly as to reduce torque fluctuations present in the continuously variable transmission.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

Other objects, advantages and features of the present invention will become more apparent upon reading of the following non-restrictive description of illustrative embodiments thereof, given by way of example only with reference to the accompanying drawings.

Generally stated, illustrative embodiments described herein are concerned with a dual-cavity toroidal CVT provided with co-axial input/output arrangement where a drum assembly is used to transfer torque from a central driven disk of the CVT to the output shaft of the CVT and including at least one resilient member to reduce torque fluctuations present in the continuously variable transmission.

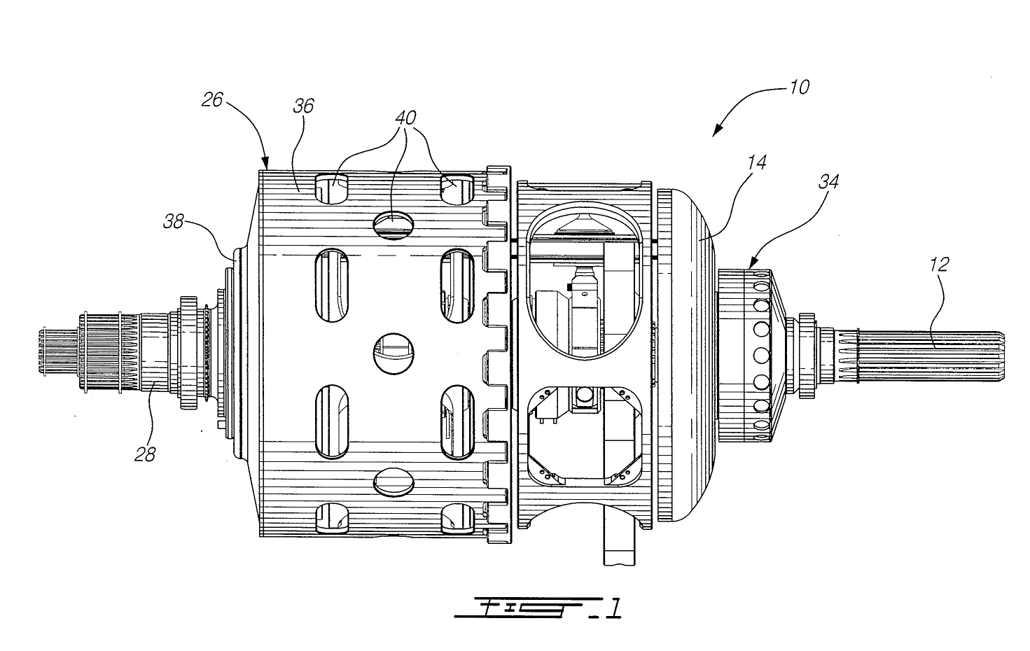

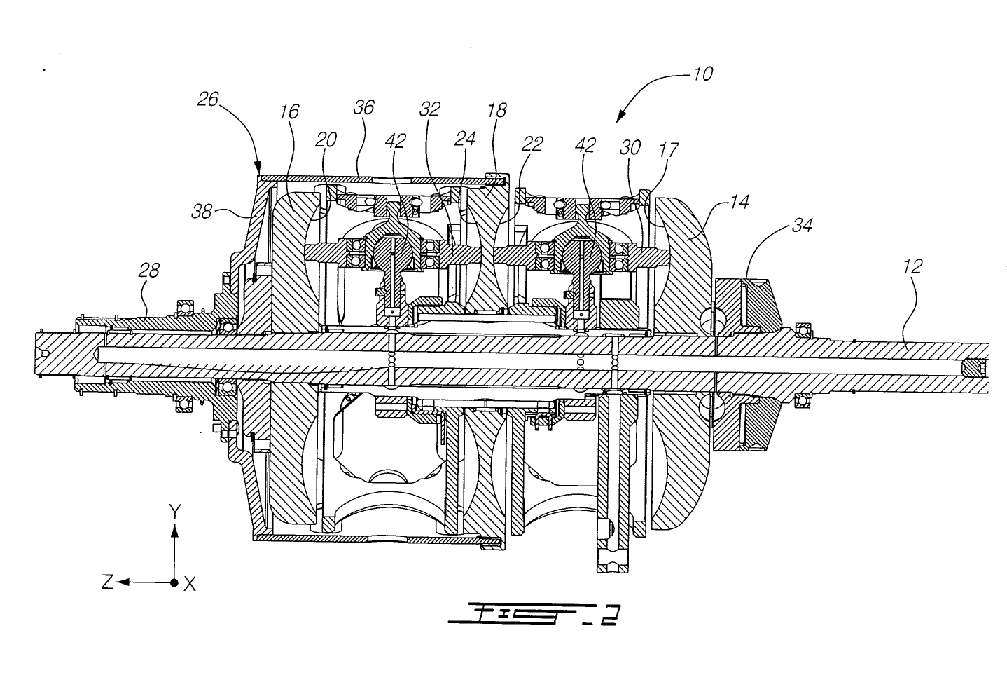

As shown in FIGS. 1 and 2, a first illustrative embodiment provides a toroidal continuously variable transmission 10 that includes an input shaft 12 for receiving power input, two driving disks 14, 16 provided with respective toroidal surfaces 17, 20, a driven disk 18 provided with two opposite toroidal surfaces 22, 24 respectively facing the toroidal surfaces 17 and 20 and a drum assembly 26 including an output shaft 28 transmitting the power output. Positioned between the driving disks 14 and 16 and the driven disk 18 are drive rollers 30, 32 that are suitable for transferring rotational motion from the driving disks 14 and 16 to the driven disk 18. More specifically, the drive rollers 30, 32 rotate between the toroidal surfaces of the driving disks 14, 16 and the driven disk 18, such that by changing the angle of the drive rollers 30, 32 in relation to the driving disks 14, 16 and the driven disks 18, there is a ratio change between the speed of rotation of the driving disks 14, 16 and the speed of rotation of the driven disk 18.

The driving shaft 12 is fixedly connected to the driving disk 16 and to a tension applying mechanism 34 that is positioned next to the driving disk 14 to exert a compression force on the driving disk 14. As such, this topology is able to provide sufficient clamping at min/max loading to run efficiently.

As the driving disks 14, 16 rotate, they cause the drive rollers 28, 30 to rotate, which in turn causes the driven disk 18 to rotate. The driven disk 18 rotates about the same axis as the driving disks 14, 16 and the driving shaft 12.

As can be better seen from FIG. 2, the drum assembly 26 includes a tubular drum 36, a flange 38 and the aforementioned output shaft 28. The drum assembly 26 therefore has a first end defining the output shaft of the CVT 10 and a second end mounted to the outer circumference of the driven disk 18. As such, the tubular drum 36 surrounds the drive rollers 30 that are positioned between the driven disk 18 and the driving disk 16. The output shaft 28 is positioned around the input shaft 12 such that the output shaft 28 and the input shaft 12 are coaxial. It should be appreciated that the drum assembly 36 could be positioned on either side of the driven disk 18, such that the output shaft 28 could be positioned on either side of the CVT 10.

The CVT 10 is able to adequately manage forces that are applied to, and generated by, the CVT system. More specifically, by having coaxial input shaft 12 and output shaft 28, there are minimal to no radial forces applied to the driven disk 18. In addition, the drum assembly 26 that is the output coupling also acts as an arrangement to reduce fluctuations of torque that are generated by and/or applied to the CVT system as will be described hereinbelow.

The drum assembly 26, including the tubular drum 36, the flange 38 and the output shaft 26 may retrieve torque from the center disk 18 and transmit that torque without affecting efficiency.

Conventionally, during the CVT operation, lubrication fluid, particularly so-called traction fluid, is applied to the CVT such that there is no or minimal metal-on-metal contact. Instead, between the moving parts, and specifically between the drive rollers 20 and the toric surfaces of the driving disks 14, 16 and the driven disk 18, there is a film of lubrication fluid between the metal surfaces.

The tubular drum 36 includes a plurality of apertures 40 allowing the lubrication fluid to drain out of the tubular drum 36. It should be appreciated that the apertures 40 can be of any shape and size, so long as they allow the transfer of the lubrication fluid from inside the tubular drum 36 to outside the tubular drum 36. The apertures 40 act as drainage holes to allow the lubrication fluid to drain out of the cavity where the drive rollers 30 are located. Once outside the tubular drum 36, the lubrication fluid is able to move along the outer casing (not shown) of the CVT into a reservoir area (also not shown).

In order to transfer rotation from the driving disks 14, 16 to the driven disks 18, the drive rollers 30, 32 rotate substantially about the y-axis. More specifically, the drive rollers 30, 32 tilt about a ball joint 42 that is connected to a “spider” connector 44. As such, the drive rollers 30, 32 are able to rotate about the ball joint such that the drive rollers rotate about the y-axis. While the drive rollers rotate about the y-axis, the spider connector 44 rotates about a central axis (z-axis) that is also the axis of rotation of the input and output shafts 12 and 26.

It is believed that the general operation of a toroidal CVT is known to those skilled in the art and will therefore not be described herein, for concision purpose.

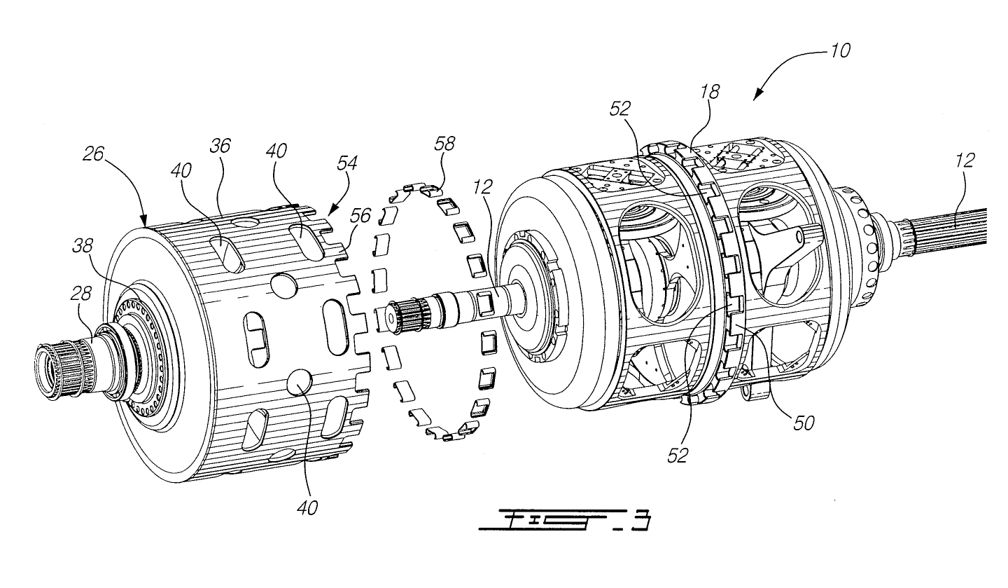

Turning now to FIG. 3 of the appended drawings, illustrating a partially exploded view of the CVT of FIG. 1, some torque fluctuations reducing features of the drum assembly 26 will be described.

As can be seen from this figure, the driven disk 18 includes a peripheral surface provided with a plurality of teeth 50 defining generally rectangular slots 52 therebetween.

The free end 54 of the tubular drum 36 of the drum assembly 26 includes generally rectangular teeth 56 slightly smaller than the generally rectangular slots 52 of the driven disk 18. The rectangular teeth 56 and the rectangular slots 52 thereby defining corresponding interlocking elements.

Interposed between the teeth 56 and the slots 52 are resilient elements 58 interconnecting the tubular drum 36 to the driven disk 18. As a non-limiting example, the resilient elements 58 can be made of polyurethane. IT has been found that the material named Gyftane ® E-8370 made by Plastique GyF Itée, located in the province of Quebec, Canada is appropriate to manufacture the resilient elements 58. Of course, other suitable materials such as, for example other polyurethanes, other elastic materials or polymers could be used.

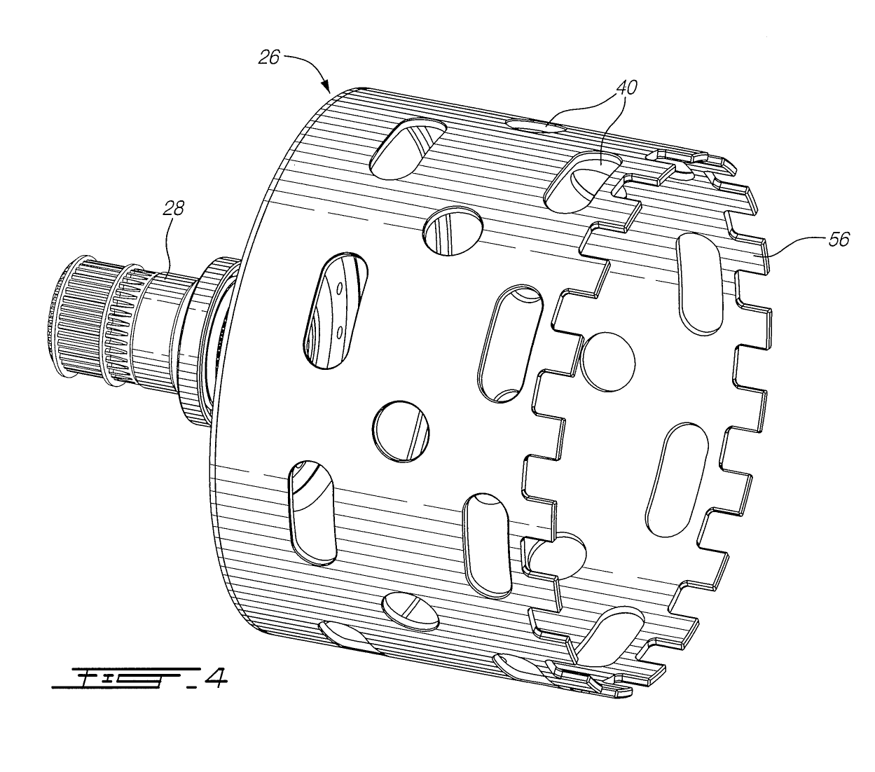

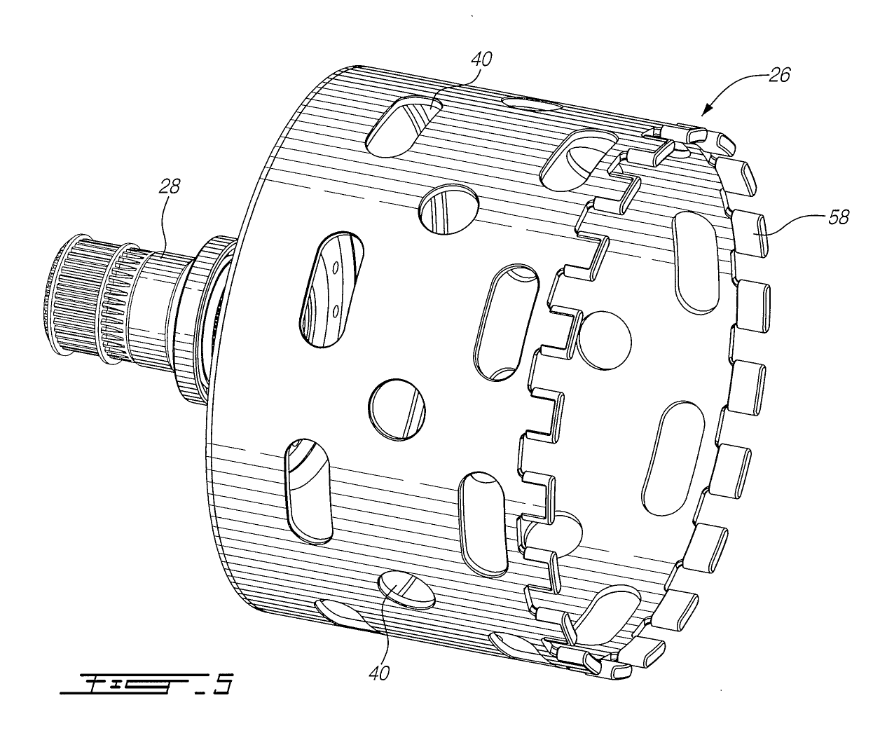

FIG. 4 illustrates the drum assembly 26 before the resilient elements 58 are mounted to the teeth 56 and FIG. 5 illustrates the drum assembly 26 with the resilient elements 58 mounted thereto.

As can be better seen from FIG. 5, the resilient elements 58 are so designed as to completely cover the portions of the teeth 56 that are facing the slots 52 to ensure that no direct contact is present between the teeth 56 and the slots 52.

In operation, the input shaft 12 of the CVT 10 is connected to a mechanical power generator, for example an Internal Combustion Engine (ICE, not shown) that rotates the input shaft 12 at a predetermined or variable speed. However, the nature of ICE technology is such that fluctuations of torque are induced in the input shaft 12.

These fluctuations of torque are generated by variations in the torque supplied by the ICE. Furthermore, some larger torque fluctuations can be generated at startup and shutdown of the ICE.

Since the output shaft 28 of a CVT such as 10 is often connected to an electric power generator (not shown), it is interesting to reduce the torque fluctuations present in the mechanical power supplied thereto. It is to be noted that the electric power generator connected to the output shaft of the CVT may also induce some torque fluctuation in the CVT, when power demand suddenly changes, for example.

These torque fluctuation, for example torsional vibrations, are undesirable and potential damageable in any powertrain.

Accordingly, the resilient elements 58 interconnecting the driven disk 18 and the tubular drum 36 are adequate to absorb the fluctuations of torque induced in the CVT 10 or generated thereby to therefore allow the output shaft 28 to deliver torque having reduced fluctuations. Indeed, the resilient elements 58 are made of a material that does not “obey” to these small fluctuations of torque but still transfers the torque from the driven disk 18 to the tubular drum 36.

The apertures 40 of the tubular drum 36 may also contribute to the reduction of torque fluctuations of the output shaft 28. Indeed, by weakening the structure of the tubular drum 36, the staggered apertures 40 may allow the drum 36 to be slightly elastically deformed should strong torque fluctuations be induced therein.

One skilled in the art will understand that the number, configuration and size of the teeth 56, the corresponding slots 52 and the resilient elements 58 are shown herein for illustration purpose only. Indeed, the number, configuration and size of these elements could vary according to the size of the CVT 10 and/or according to the intended purpose thereof.

It will be apparent to one skilled in the art that the individual resilient elements 58 could be replaced by a continuous resilient element (not shown) by slightly modifying the teeth 56 and/or the slots 52 to allow for such a continuous resilient element.

It will also be apparent that other corresponding interlocking elements could be provided on the free end 54 of the tubular drum 36 and on the driven disk 18 as long as a resilient element can be positioned therebetween.

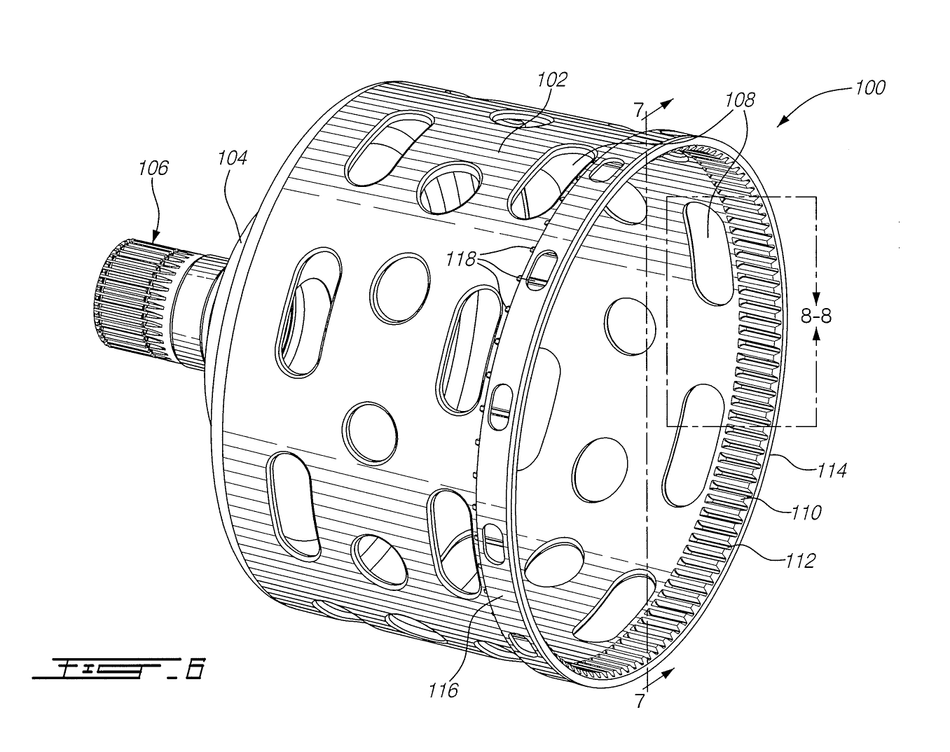

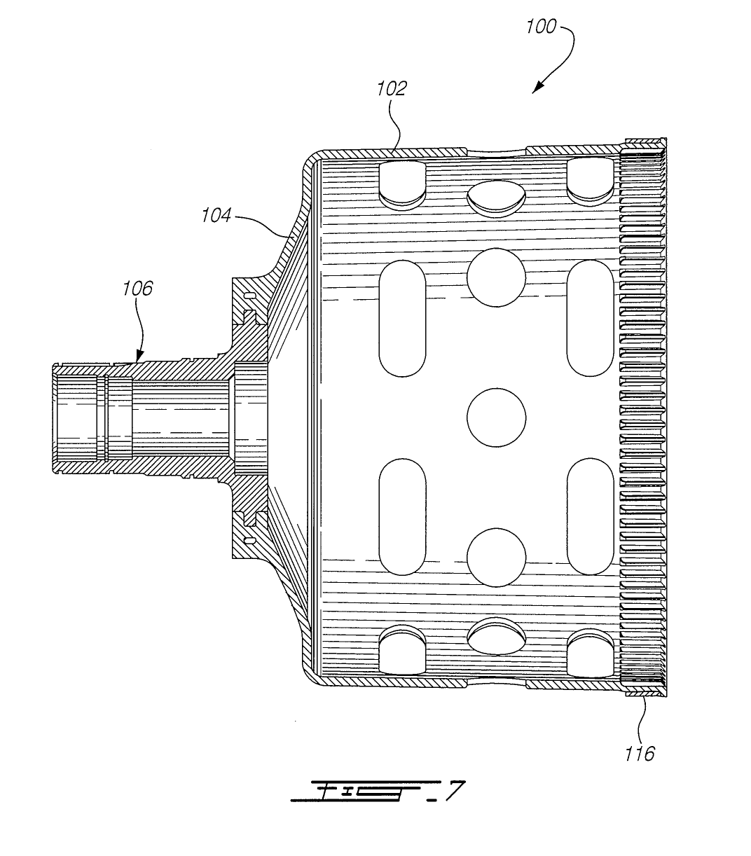

Turning now to FIGS. 6 to 8 of the appended drawings a drum assembly 100 according to a second illustrative embodiment will be described.

The drum assembly 100 includes a tubular drum 102 integral with a flange 104, both made of a plastic material which has been over-molded onto an output shaft 106.

By using a suitable plastic material, such as, for example Nylon 6 that has been charged with long and thin glass fibers, it is possible to mould a tubular drum with integral flange that has the desired properties to adequately transfer the torque from the driven disk 18 (see FIG. 2) to the output shaft 106 while reducing the torque fluctuations as described hereinabove. Indeed, the nature of the Nylon 6 charged with glass fibers allows it to be slightly plastically deformed by the fluctuations of torque applied thereto to reduce these fluctuations.

More specifically, charging the Nylon 6 with about 25% by weight of glass fibers having a length of about 400 μm and a diameter of about 10 μm have been found adequate. Of course, other adequate materials and/or types of charging of the material could be used.

As can be seen in the appended figures, the tubular drum 102 includes staggered apertures 108 both to allow the lubrication fluid to egress the drum 102 and to help reducing the torque fluctuations as described hereinabove.

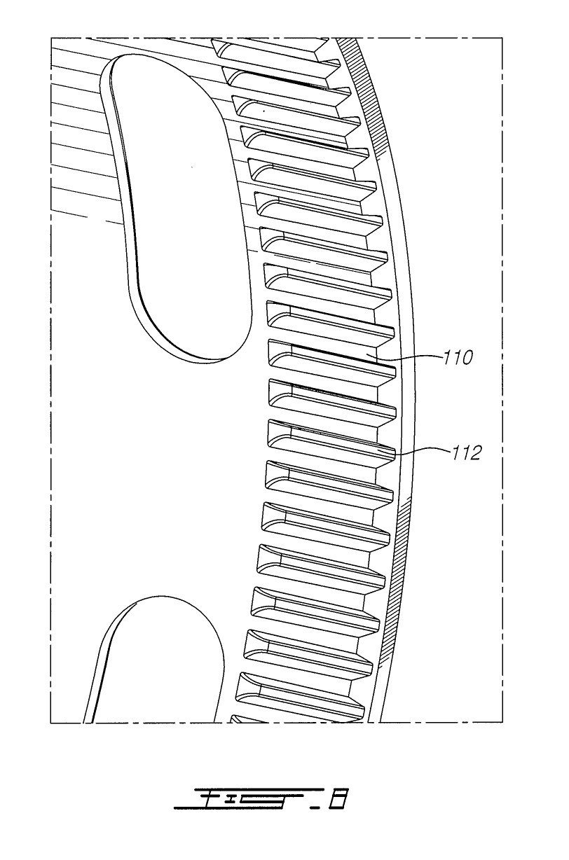

FIG. 8 shows the teeth 110 and slots 112 of the free end 114 of the tubular drum 102. Of course, the peripheral portion (not shown) of the driven disk 18 has corresponding teeth and slots to allow the free end 114 of the drum 102 to be mounted thereto. The teeth 110 and slots 112 and the corresponding teeth and slot (not shown) of the fee end 114 of the drum 102 therefore define corresponding interlocking elements.

To strengthen the connection between the free end 114 of the drum 102 and the driven disk 18, a tightening belt 116 is mounted to the free end 114 after the free end 114 is connected to the driven disk 18. This belt, which may be made of steel, ensures that the connection between the drum 106 and the disk 18 is maintained should temperature increase temporarily change the stiffness of the drum 106, for example.

Returning to FIG. 6, the outer surface of the drum 106 includes ridges 118 near the free end 114 thereof to improve the structure of the drum 106.

As will be understood by one skilled in the art, other suitable plastic materials could be used to mould the drum 106.

While the above description states that the shaft 12 is used to input mechanical power into the CVT and the shaft 28 or 106 are used to output mechanical power from the CVT, these roles of the shafts 12, 28 and 106 could be reversed. In other words, mechanical power could be supplied to the CVT via the drum arrangement and could be supplied by the CVT via the shaft 12.

While the above illustrative embodiments were concerned with a dual-cavity CVT, one skilled in the art will understand that a single-cavity CVT would also benefit from the torque fluctuations reductions arrangements described herein.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A continuously variable transmission including:
a shaft defining a longitudinal axis; the shaft defining an input/output of the continuously variable transmission;
a first drive disk mounted to the shaft and provided with a toroidal surface;
a driven disk rotatably mounted to the shaft and having a first toroidal surface facing the toroidal surface of the first drive disk, a second toroidal surface and a peripheral surface;
a second drive disk mounted to the shaft and provided with a toroidal surface facing the second toroidal surface of the driven disk;
a first set of rollers interconnecting the toroidal surface of the first drive disk with the first toroidal surface of the driven disk;
a second set of rollers interconnecting the toroidal surface of the second drive disk with the second toroidal surface of the driven disk; and
a drum assembly enclosing one of the first and second drive disks; the drum assembly having a first longitudinal end defining an output/input of the continuously variable transmission and a second longitudinal end;
wherein a) the second longitudinal end of the drum assembly is resiliently interconnected to the driven disk and b) the resilient interconnection reduces torque fluctuations present in the continuously variable transmission.

2. The continuously variable transmission recited in claim 1, wherein the shaft defines an input of the continuously variable transmission and wherein the first longitudinal end of the drum assembly defines an output of the continuously variable transmission.

3. The continuously variable transmission recited in claim 1, wherein the drum assembly includes a tubular drum defining the second longitudinal end, a shaft defining the first longitudinal end and a flange interposed between the tubular drum and the shaft.

4. The continuously variable transmission recited in claim 3, wherein the tubular drum and the flange are integral.

5. The continuously variable transmission recited in claim 4, wherein the tubular drum and flange are made of plastic material; the resilient interconnection between the drum assembly and the driven disk being provided by the plastic material forming the tubular drum.

6. The continuously variable transmission recited in claim 5, wherein the plastic material includes Nylon 6 and fibers.

7. The continuously variable transmission recited in claim 5, wherein the second longitudinal end of the drum assembly and the peripheral portion of the driven disk include corresponding interlocking elements.

8. The continuously variable transmission recited in claim 7, further comprising a tightening belt provided about the second longitudinal end of the drum assembly.

9. The continuously variable transmission recited in claim 1, wherein the second longitudinal end of the drum assembly and the peripheral surface of the driven disk include corresponding interlocking elements; the continuously variable transmission further including at least one resilient element interposed between the corresponding interlocking elements of the drum assembly and the peripheral surface to provide the resilient interconnection therebetween.

10. The continuously variable transmission recited in claim 9, wherein the at least one resilient element includes polyurethane.

11. The continuously variable transmission recited in claim 9, wherein the corresponding interlocking elements include generally rectangular teeth provided at the second longitudinal end of the drum assembly and generally rectangular slots provided on the peripheral surface of the driven disk.

12. The continuously variable transmission recited in claim 1, wherein the drum assembly includes a tubular drum provided with openings so configured and sized as to weaken a structure of the tubular drum to allow the tubular drum to be elastically deformed by torque fluctuations applied thereto.

13. A continuously variable transmission including:
a shaft defining a longitudinal axis; the shaft defining an input/output of the continuously variable transmission;
a first drive disk mounted to the shaft and provided with a toroidal surface;
a driven disk rotatably mounted to the shaft and having a first toroidal surface facing the toroidal surface of the first drive disk, a second toroidal surface and a peripheral surface;
a second drive disk mounted to the shaft and provided with a toroidal surface facing the second toroidal surface of the driven disk;
a first set of rollers interconnecting the toroidal surface of the first drive disk with the first toroidal surface of the driven disk;
a second set of rollers interconnecting the toroidal surface of the second drive disk with the second toroidal surface of the driven disk;
a drum assembly enclosing one of the first and second drive disks; the drum assembly has a first longitudinal end defining an output/input of the continuously variable transmission and a second longitudinal end; and
at least one resilient element interconnecting the second longitudinal end of the drum assembly and the driven disk;
wherein the at least one resilient element reduces the torque fluctuation present in the continuously variable transmission.

14. The continuously variable transmission recited in claim 13, wherein the shaft defines an input of the continuously variable transmission and wherein the first longitudinal end of the drum assembly defines an output of the continuously variable transmission.

15. The continuously variable transmission recited in claim 13, wherein the drum assembly includes a tubular drum defining the second longitudinal end, a shaft defining the first longitudinal end and a flange interposed between the tubular drum and the shaft.

16. The continuously variable transmission recited in claim 13, wherein the second longitudinal end of the drum assembly and the peripheral portion of the driven disk include corresponding interlocking elements.

17. The continuously variable transmission recited in claim 16, wherein the corresponding interlocking elements include generally rectangular teeth provided at the second longitudinal end of the drum assembly and generally rectangular slots provided on the peripheral surface of the driven disk.

18. The continuously variable transmission recited in claim 13, wherein the at least one resilient element includes polyurethane.

19. The continuously variable transmission recited in claim 13, wherein the drum assembly includes a tubular drum provided with openings so configured and sized as to weaken a structure of the tubular drum to allow the tubular drum to be elastically deformed by torque fluctuations applied thereto.

20. A continuously variable transmission including:
a shaft defining a longitudinal axis; the shaft defining an input/output of the continuously variable transmission;
a first drive disk mounted to the shaft and provided with a toroidal surface;
a driven disk rotatably mounted to the shaft and having a first toroidal surface facing the toroidal surface of the first drive disk, a second toroidal surface and a peripheral surface;
a second drive disk mounted to the shaft and provided with a toroidal surface facing the second toroidal surface of the driven disk;
a first set of rollers interconnecting the toroidal surface of the first drive disk with the first toroidal surface of the driven disk;
a second set of rollers interconnecting the toroidal surface of the second drive disk with the second toroidal surface of the driven disk; and
a drum assembly including a tubular drum provided with first and second longitudinal ends and an output/input shaft mounted to the first longitudinal end; the tubular drum being made of a resilient material and enclosing one of the first and second drive disk; the second longitudinal end being mounted to the driven disk;
wherein the resilient material of the tubular drum reduces torque fluctuations present in the continuously variable transmission.

21. The continuously variable transmission recited in claim 20, wherein the shaft defines an input of the continuously variable transmission and wherein the first longitudinal end of the drum assembly defines an output of the continuously variable transmission.

22. The continuously variable transmission recited in claim 20, wherein the drum assembly further includes a flange interposed between the tubular drum and the output/input shaft.

23. The continuously variable transmission recited in claim 22, wherein the tubular drum and the flange are integral.

24. The continuously variable transmission recited in claim 20, wherein the tubular drum is made of plastic material.

25. The continuously variable transmission recited in claim 24, wherein the plastic material includes Nylon 6 and fibers.

26. The continuously variable transmission recited in claim 24, wherein the second longitudinal end of the drum assembly and the peripheral portion of the driven disk include corresponding interlocking elements.

27. The continuously variable transmission recited in claim 26, further comprising a tightening belt provided about the second longitudinal end of the drum assembly.

28. The continuously variable transmission recited in claim 20, wherein the tubular drum is provided with openings so configured and sized as to enhance the structure of the tubular drum to allow the tubular drum to be elastically deformed by torque fluctuations applied thereto.

29. A continuously variable transmission including:
a shaft defining a longitudinal axis; the shaft defining an input/input of the continuously variable transmission;
a first drive disk mounted to the shaft and provided with a toroidal surface;
a driven disk rotatably mounted to the shaft and having a first toroidal surface facing the toroidal surface of the first drive disk, a second toroidal surface and a peripheral surface;
a second drive disk mounted to the shaft and provided with a toroidal surface facing the second toroidal surface of the driven disk;
a first set of rollers interconnecting the toroidal surface of the first drive disk with the first toroidal surface of the driven disk;
a second set of rollers interconnecting the toroidal surface of the second drive disk with the second toroidal surface of the driven disk;
a drum assembly enclosing one of the first and second drive disk; the drum assembly having a first longitudinal end defining an output/input of the continuously variable transmission and a second longitudinal end connected to the peripheral surface of the driven disk; and
at least one resilient member so associated with at least one of the longitudinal shaft, the first drive disk, the second drive disk, the driven disk and the drum assembly as to reduce torque fluctuations present in the continuously variable transmission.
